(19) United States
(12) Patent Application Publication
(10) Pub. No.: US 2016/0342699 A1
(43) Pub. Date: Nov. 24, 2016

(54) SYSTEMS, METHODS, AND DEVICES FOR PROFILING AUDIENCE POPULATIONS OF WEBSITES

(71) Applicant: Turn Inc., Redwood City, CA (US)

(72) Inventors: Jianqiang Shen, Redwood City, CA (US); Ali Dasdan, Redwood City, CA (US)

(73) Assignee: Turn Inc., Redwood City, CA (US)

(21) Appl. No.: 14/715,040

(22) Filed: May 18, 2015

(51) Int. Cl. G06F 17/30; G06Q 30/02

(52) U.S. Cl. CPC G06F 17/30876; G06F 17/30345; G06Q 30/0269; G06Q 30/0277

(57) ABSTRACT

Disclosed herein are systems, methods, and devices for profiling audience populations of websites. Systems include a data structure generator configured to generate a first plurality of data structures based on reference data characterizing a first plurality of audience profiles associated with a plurality of seed websites. The data structure generator is further configured to generate a second plurality of data structures based on first audience profile data characterizing a second plurality of audience profiles associated with the plurality of seed websites, the first audience profile data being generated by an online advertisement service provider. Systems include an audience profile model generator configured to generate an audience profile model based on a relationship between the first plurality of data structures and the second plurality of data structures, the audience profile model generator also configured to generate estimated audience profiles in response to receiving second audience profile data associated with candidate websites.

### TECHNICAL FIELD

This disclosure generally relates to online advertising, and more specifically to profiling audience populations of websites associated with online advertising.

### BACKGROUND

In online advertising, internet users are presented with advertisements as they browse the internet using a web browser or mobile application. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

### SUMMARY

Disclosed herein are systems, methods, and devices for profiling audience populations of websites. Systems may include a data structure generator configured to generate a first plurality of data structures based on reference data characterizing a first plurality of audience profiles associated with a plurality of seed websites, the reference data being generated by a reference data provider. In some embodiments, the data structure generator is further configured to generate a second plurality of data structures based on first audience profile data characterizing a second plurality of audience profiles associated with the plurality of seed websites, the first audience profile data being generated by an online advertisement service provider. In some embodiments, the systems further include an audience profile model generator configured to generate an audience profile model based on a relationship between the first plurality of data structures and the second plurality of data structures, the audience profile model generator being further configured to generate, using the audience profile model, an estimated audience profile in response to receiving second audience profile data associated with a candidate website.

In some embodiments, the first data structures include a first plurality of data fields, wherein each data field of the first plurality of data fields is configured to store one or more data values characterizing a data event or user profile data included in the reference data. In various embodiments, the second data structures include a second plurality of data fields, wherein each data field of the second plurality of data fields is configured to store one or more data values characterizing a data event or user profile data included in the first audience profile data. In some embodiments, the first plurality of data fields included in the first data structures and the second plurality of data fields included in the second data structures are arranged as vector arrays. Moreover, the relationship between the first plurality of data structures and the second plurality of data structures may be determined based on a regression analysis between the first data structures and the second data structures. In various embodiments, the relationship between the first plurality of data structures and the second plurality of data structures is determined based on a plurality of rules generated by the audience profile model generator, each rule of the plurality of rules being generated based on a comparison of the reference data and the first audience profile data.

In various embodiments, the estimated audience profile represents an estimate of an audience profile generated by the reference data provider in response to an online advertisement campaign being implemented on the candidate website. According to some embodiments, the candidate website is different than each seed website of the plurality of seed websites. In various embodiments, the systems further include a data analyzer configured to generate a forecast based, at least in part, on the estimated audience profile, the forecast including a prediction of an outcome of implementing an online advertisement campaign on the candidate website. In some embodiments, the data analyzer is further configured to generate a recommendation based, at least in part, on the estimated audience profile, the recommendation identifying whether the online advertiser should implement the online advertisement campaign on the candidate website.

Also disclosed herein are systems that include at least a first processing node configured to generate a first plurality of data structures based on reference data characterizing a first plurality of audience profiles associated with a plurality of seed websites, the reference data being generated by a reference data provider. In some embodiments, the systems also include at least a second processing node configured to generate a second plurality of data structures based on first audience profile data characterizing a second plurality of audience profiles associated with the plurality of seed websites, the first audience profile data being generated by an online advertisement service provider. In various embodiments, the systems also include at least a third processing node configured to generate an audience profile model based on a relationship between the first plurality of data structures and the second plurality of data structures, the at least a third processing node being further configured to generate, using the audience profile model, an estimated audience profile in response to receiving second audience profile data associated with a candidate website.

In various embodiments, the first data structures include a first plurality of data fields, wherein each data field of the first plurality of data fields is configured to store one or more data values characterizing a data event or user profile data included in the reference data. In some embodiments, the second data structures include a second plurality of data fields, wherein each data field of the second plurality of data fields is configured to store one or more data values characterizing a data event or user profile data included in the first audience profile data. According to various embodiments, the relationship between the first plurality of data structures and the second plurality of data structures is determined based on a regression analysis between the first data structures and the second data structures. In some embodiments, the estimated audience profile represents an estimate of an audience profile generated by the reference data provider in response to an online advertisement campaign being implemented on the candidate website. According to some embodiments, the candidate website is different than each seed website of the plurality of seed websites.

Also disclosed herein are one or more non-transitory computer readable media having instructions stored thereon for performing a method, the method including generating a first plurality of data structures based on reference data characterizing a first plurality of audience profiles associated with a plurality of seed websites, the reference data being generated by a reference data provider. The methods may also include generating a second plurality of data structures based on first audience profile data characterizing a second plurality of audience profiles associated with the plurality of seed websites, the first audience profile data being generated by an online advertisement service provider. The methods may further include generating an audience profile model based on a relationship between the first plurality of data structures and the second plurality of data structures, the audience profile model being capable of generating an estimated audience profile in response to receiving second audience profile data associated with a candidate website.

In some embodiments, the first data structures include a first plurality of data fields, wherein each data field of the first plurality of data fields is configured to store one or more data values characterizing a data event or user profile data included in the reference data. In various embodiments, the second data structures include a second plurality of data fields, wherein each data field of the second plurality of data fields is configured to store one or more data values characterizing a data event or user profile data included in the first audience profile data. In some embodiments, the relationship between the first plurality of data structures and the second plurality of data structures is determined based on a regression analysis between the first data structures and the second data structures. In various embodiments, the estimated audience profile represents an estimate of an audience profile generated by the reference data provider in response to an online advertisement campaign being implemented on the candidate website. In some embodiments, the methods further include generating a forecast based, at least in part, on the estimated audience profile, the forecast including a prediction of an outcome of implementing an online advertisement campaign on the candidate website. The methods may also include generating a recommendation based, at least in part, on the estimated audience profile, the recommendation identifying whether the online advertiser should implement the online advertisement campaign on the candidate website.

Details of one or more embodiments of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 illustrates an example of an advertiser hierarchy, implemented in accordance with some embodiments.

FIG. 2 illustrates a diagram of an example of a system for profiling audience populations of websites, implemented in accordance with some embodiments.

FIG. 3 illustrates a flow chart of an example of an audience profile model generation method, implemented in accordance with some embodiments.

FIG. 4 illustrates a flow chart of an example of another audience profile model generation method, implemented in accordance with some embodiments.

FIG. 5 illustrates a flow chart of an example of an online advertisement campaign forecast generation method, implemented in accordance with some embodiments.

FIG. 6 illustrates a flow chart of an example of online advertisement campaign recommendation generation method, implemented in accordance with some embodiments.

FIG. 7 illustrates a data processing system configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

In online advertising, advertisers often try to provide the best ad for a given user in an online context. Advertisers often set constraints which affect the applicability of the advertisements. For example, an advertiser might try to target only users in a particular geographical area or region who may be visiting web pages of particular types for a specific campaign. Thus, an advertiser may try to configure a campaign to target a particular group of end users, which may be referred to herein as an audience. As used herein, a campaign may be an advertisement strategy which may be implemented across one or more channels of communication. Furthermore, the objective of advertisers may be to receive as many user actions as possible by utilizing different campaigns in parallel. As previously discussed, an action may be the purchase of a product, filling out of a form, signing up for e-mails, and/or some other type of action. In some embodiments, actions or user actions may be advertiser-defined and may include an affirmative act performed by a user, such as inquiring about or purchasing a product and/or visiting a certain page.

In various embodiments, an ad from an advertiser may be shown to a user with respect to publisher content, which may be a website or mobile application if the value for the ad impression opportunity is high enough to win in a real-time auction. Advertisers may determine a value associated with an ad impression opportunity by determining a bid. In some embodiments, such a value or bid may be determined based on the probability of receiving an action from a user in a certain online context multiplied by the cost-per-action goal an advertiser wants to achieve. Once an advertiser, or one or more demand-side platforms that act on their behalf, wins the auction, it is responsible to pay the amount that is the winning bid.

When implementing an online advertisement campaign across different websites, it is useful to know what the audience population, or group of users, that uses the website includes. For example, if an advertiser intends to target an audience that includes women, it is useful to be able to identify websites that have audiences primarily comprised of women. Utilizing such data about the website's audience may enable an online advertiser to efficiently select websites on which to advertise, and efficiently implement the online advertisement campaign in a way that reaches a large audience for a particular budget. As disclosed herein, data anonymously identifying or characterizing the audience or group of users that use a website may be an audience profile associated with that website. For example, an audience profile may include data that characterizes a size of an overall population of visitors or users served by the website, a distribution of male and female users, a distribution of users' ages, a distribution of users' geographical locations, a distribution of users' marital status, a distribution of users' associated data categories or tags, a distribution of users' education levels, and a distribution of users' incomes.

Conventional techniques for getting an accurate estimation of the audience population of a website may be costly and impractical. For example, online advertisers may rely entirely on independent survey agencies to conduct surveys. Given that there are millions of websites upon which advertisements may be placed, a conventional analysis of such websites takes more time than is feasible and is cost prohibitive. Accordingly, conventional techniques are not able to generate audience profiles for potentially relevant websites or recommend such websites to the online advertiser when the online advertiser implements an online advertisement campaign.

Various systems, methods, and devices disclosed herein provide the profiling of audience populations of websites on a large scale applicable to an online advertising environment. As disclosed herein, seed websites may be identified and reference data may be obtained from a reference data provider for the identified seed websites. As will be discussed in greater detail below, the reference data provider may be an independent survey agency or a “gold-standard” of data provider, such as The Nielsen Company. The reference data may be compared with audience profile data that may have been collected by an online advertisement service provider to form or generate an audience profile model, which may be capable of generating an estimated audience profile in response to receiving data associated with a candidate website. In general, reference or “gold-standard” data from a reference data provider differs from audience profile data from an online advertisement service provider in that reference data may be obtained from different data sources and is typically represented as aggregate data. Accordingly, reference data may include aggregate numbers over a period of time, but not data specific to a particular user. For example, reference data may include a total count of female users and male users within a particular day, the reference data might not provide any data about each user. Accordingly, reference data on its own is not capable of being used to implement an online advertisement campaign.

Accordingly, a relatively small sample size of seed websites may be used to generate an audience profile model which may subsequently approximate or estimate outcomes that would be generated by a reference data provider for candidate websites. In this way, once the audience profile model has been generated, it may be used to process large amounts of audience profile data to generate estimated audience profiles for candidate websites without additional use of a reference data provider or independent survey agency. Because no additional reference data is needed once the audience profile model has been generated, large amounts of websites may be processed and used to provide accurate recommendations to online advertisers in real-time. In some embodiments, the sample size of seed websites may be about 120 websites. As will be discussed in greater detail below, the audience profile model may be used to analyze over 8 million websites. In this way, very large quantities of websites may be analyzed to generate extensive estimates of audience profiles as well as extensive estimates of the results of implementing online advertisement campaigns on websites associated with those audience profiles.

Accordingly, various embodiments disclosed herein provide novel estimations population data associated with websites, thus increasing the quality and accuracy of data underlying the implementation and analysis of online advertisement campaigns. Received data may be used to generate novel audience profile models which may be used to increase the effectiveness of targeting for online advertisement campaigns. In this way, processing systems used to implement such estimations may be improved to implement online advertisement campaigns more effectively and to process underlying data faster. In various embodiments, the generation of audience profile models enables processing systems to generate forecasts and to target online advertisement campaigns in ways not previously possible. Moreover, embodiments disclosed herein enable processing systems to analyze data faster such that greater amounts of data may be analyzed and used within a particular operational window.

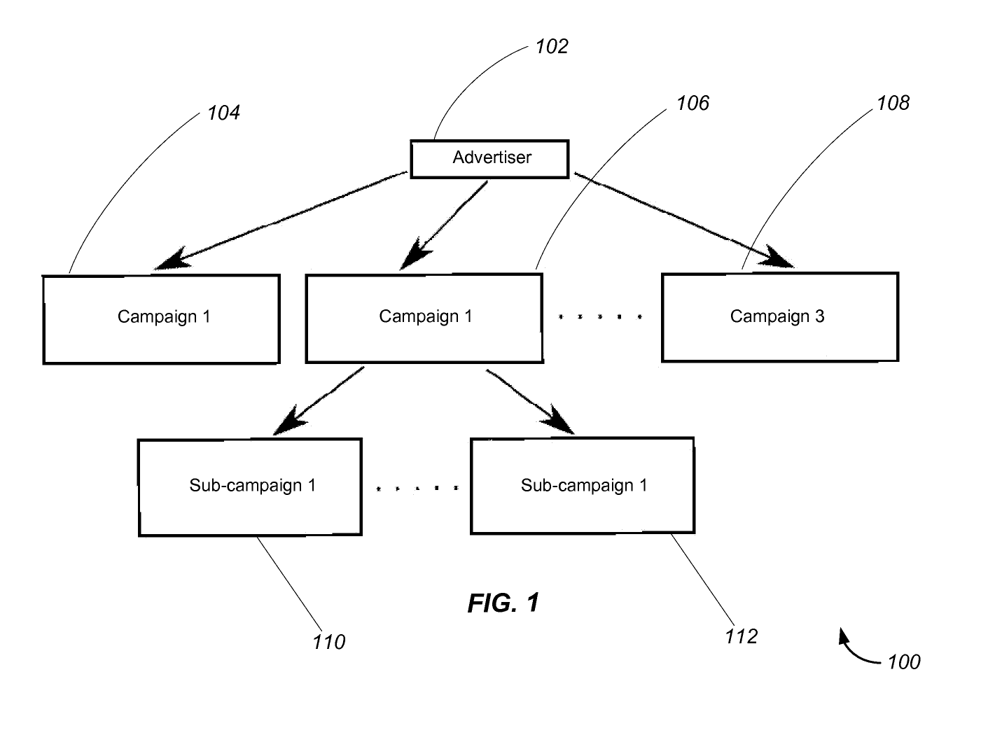

FIG. 1 illustrates an example of an advertiser hierarchy, implemented in accordance with some embodiments. As previously discussed, advertisement servers may be used to implement various advertisement campaigns to target various users or an audience. In the context of online advertising, an advertiser, such as the advertiser 102, may display or provide an advertisement to a user via a publisher, which may be a web site, a mobile application, or other browser or application capable of displaying online advertisements. The advertiser 102 may attempt to achieve the highest number of user actions for a particular amount of money spent, thus, maximizing the return on the amount of money spent. Accordingly, the advertiser 102 may create various different tactics or strategies to target different users. Such different tactics and/or strategies may be implemented as different advertisement campaigns, such as campaign 104, campaign 106, and campaign 108, and/or may be implemented within the same campaign. Each of the campaigns and their associated sub-campaigns may have different targeting rules which may be referred to herein as an audience segment. For example, a sports goods company may decide to set up a campaign, such as campaign 104, to show golf equipment advertisements to users above a certain age or income, while the advertiser may establish another campaign, such as campaign 106, to provide sneaker advertisements towards a wider audience having no age or income restrictions. Thus, advertisers may have different campaigns for different types of products. The campaigns may also be referred to herein as insertion orders.

Each campaign may include multiple different sub-campaigns to implement different targeting strategies within a single advertisement campaign. In some embodiments, the use of different targeting strategies within a campaign may establish a hierarchy within an advertisement campaign. Thus, each campaign may include sub-campaigns which may be for the same product, but may include different targeting criteria and/or may use different communications or media channels. Some examples of channels may be different social networks, streaming video providers, mobile applications, and web sites. For example, the sub-campaign 110 may include one or more targeting rules that configure or direct the sub-campaign 110 towards an age group of 18-34 year old males that use a particular social media network, while the sub-campaign 112 may include one or more targeting rules that configure or direct the sub-campaign 112 towards female users of a particular mobile application. As similarly stated above, the sub-campaigns may also be referred to herein as line items.

Accordingly, an advertiser 102 may have multiple different advertisement campaigns associated with different products. Each of the campaigns may include multiple sub-campaigns or line items that may each have different targeting criteria. Moreover, each campaign may have an associated budget which is distributed amongst the sub-campaigns included within the campaign to provide users or targets with the advertising content.

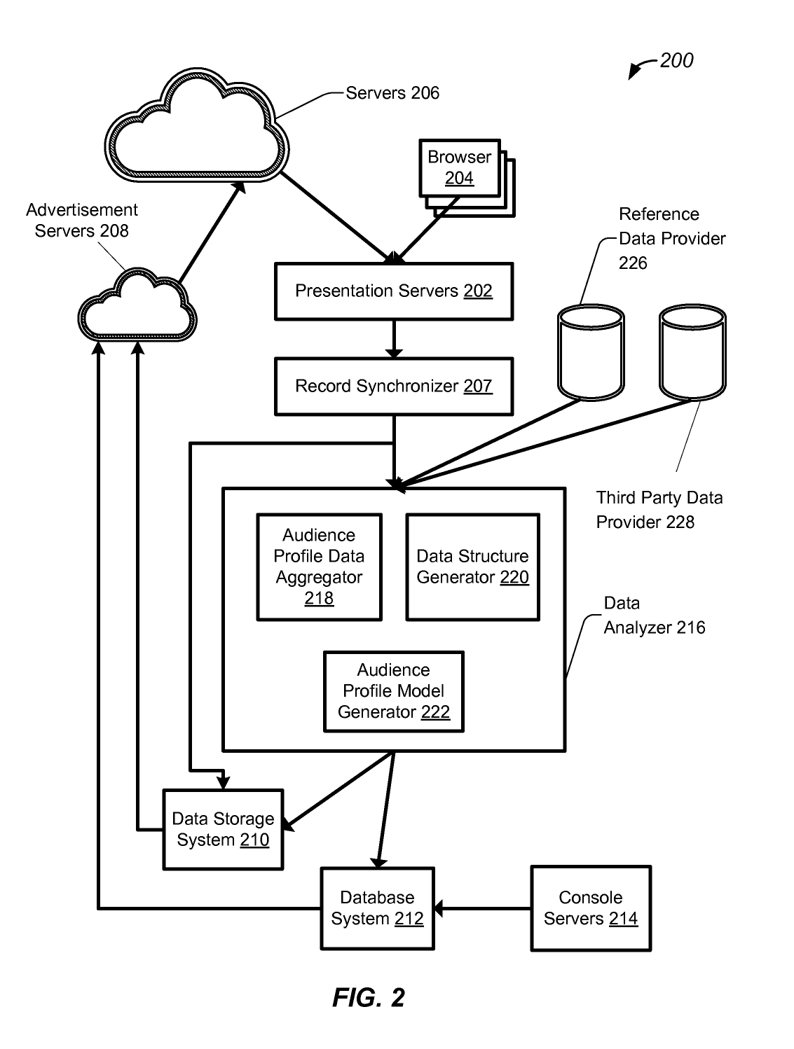

FIG. 2 illustrates a diagram of an example of a system for profiling audience populations of websites, implemented in accordance with some embodiments. As similarly discussed above, in the context of online advertising, online advertisers may set or designate various targeting parameters for an online advertisement campaign. When determining how to distribute a budget and corresponding impressions served based on such a budget, an online advertisement service provider may analyze websites to determine which websites provide the most efficient implementation of the online advertisement campaign given the online advertiser's targeting criteria. Accordingly, the online advertisement service provider may generate audience profiles that characterize or represent an audience population served by various websites. As discussed above, audience profiles generated based on data maintained by the online advertisement service provider may vary or differ from audience profiles generated by a reference data provider which may have access to a large number of high-quality data sources that may be regarded as a “gold-standard” of data. Accordingly, one or more components of system 200 may be configured to analyze data and generate one or more audience profile models that may be used to estimate the reference data of the reference data provider as well as audience profiles for websites that may be generated based on such reference data.

In various embodiments, system 200 may include one or more presentation servers, such as presentation servers 202. According to some embodiments, presentation servers 202 may be configured to aggregate various online advertising data from several data sources.

The online advertising data may include live internet data traffic that may be associated with users, as well as variety of supporting tasks. For example, the online advertising data may include one or more data values identifying various impressions, clicks, data collection events, and/or beacon fires that may characterize interactions between users and one or more advertisement campaigns. As discussed herein, such data may also be described as performance data that may form the underlying basis of analyzing a performance of one or more advertisement campaigns. In some embodiments, presentation servers 202 may be front-end servers that may be configured to process a large number of real-Internet users and associated SSL (Secure Socket Layer) handling. The front-end servers may be configured to generate and receive messages to communicate with other servers in system 200. In some embodiments, the front-end servers may be configured to perform logging of events that are periodically collected and sent to additional components of system 200 for further processing.

As similarly discussed above, presentation servers 202 may be communicatively coupled to one or more data sources such as browser 204 and servers 206. In some embodiments, browser 204 may be an Internet browser that may be running on a client machine associated with a user. Thus, a user may use browser 204 to access the Internet and receive advertisement content via browser 204. Accordingly, various clicks and other actions may be performed by the user via browser 204. Moreover, browser 204 may be configured to generate various online advertising data described above. For example, various cookies, advertisement identifiers, beacon fires, and anonymous user identifiers may be identified by browser 204 based on one or more user actions, and may be transmitted to presentation servers 202 for further processing. As discussed above, various additional data sources may also be communicatively coupled with presentation servers 202 and may also be configured to transmit similar identifiers and online advertising data based on the implementation of one or more advertisement campaigns by various advertisement servers, such as advertisement servers 208 discussed in greater detail below. For example, the additional data servers may include servers 206, which may process bid requests and generate one or more data events associated with providing online advertisement content based on the bid requests. Thus, servers 206 may be configured to generate data events characterizing the processing of bid requests and implementation of an advertisement campaign. Such bid requests may be transmitted to presentation servers 202.

In various embodiments, system 200 may further include record synchronizer 207 which may be configured to receive one or more records from various data sources that characterize the user actions and data events described above. In some embodiments, the records may be log files that include one or more data values characterizing the substance of the user action or data event, such as a click or conversion. The data values may also characterize metadata associated with the user action or data event, such as a timestamp identifying when the user action or data event took place. According to various embodiments, record synchronizer 207 may be further configured to transfer the received records, which may be log files, from various end points, such as presentation servers 202, browser 204, and servers 206 described above, to a data storage system, such as data storage system 210 or database system 212 described in greater detail below. Accordingly, record synchronizer 207 may be configured to handle the transfer of log files from various end points located at different locations throughout the world to data storage system 210 as well as other components of system 200, such as data analyzer 216 discussed in greater detail below. In some embodiments, record synchronizer 207 may be configured and implemented as a MapReduce system that is configured to implement a MapReduce job to directly communicate with a communications port of each respective endpoint and periodically download new log files.

As discussed above, system 200 may further include advertisement servers 208 which may be configured to implement one or more advertisement operations. For example, advertisement servers 208 may be configured to store budget data associated with one or more advertisement campaigns, and may be further configured to implement the one or more advertisement campaigns over a designated period of time. In some embodiments, the implementation of the advertisement campaign may include identifying actions or communications channels associated with users targeted by advertisement campaigns, placing bids for impression opportunities, and serving content upon winning a bid. In some embodiments, the content may be advertisement content, such as an Internet advertisement banner, which may be associated with a particular advertisement campaign. The terms “advertisement server” and “advertiser” are used herein generally to describe systems that may include a diverse and complex arrangement of systems and servers that work together to display an advertisement to a user's device. For instance, this system will generally include a plurality of servers and processing nodes for performing different tasks, such as bid management, bid exchange, advertisement and campaign creation, content publication, etc.

Accordingly, advertisement servers 208 may be configured to generate one or more bid requests based on various advertisement campaign criteria. As discussed above, such bid requests may be transmitted to servers 206.

In various embodiments, system 200 may include data analyzer 216 which may be configured to receive reference data and audience profile data from various different sources, analyze the received data, and generate audience profile models based on the analysis. The audience profile models may subsequently be used to generate estimated audience profiles for websites that may potentially be used to implement one or more online advertisement campaigns. As similarly discussed above, reference data may refer to data received from a reference data provider which may be a reference or “gold standard” for online data associated with online users. For example, a reference data provider, such as reference data provider 226, may be an information and measurement company such as The Nielsen Company. In some embodiments, the audience profile data may be retrieved from a data storage system, such as data storage system 210, operated and maintained by an online advertisement service provider, such as Turn® Inc., Redwood City, Calif. In various embodiments, one or more components of data analyzer 216 may be configured to analyze the data retrieved from reference data provider 226 and data storage system 210, and may be further configured to build one or more audience profile models based on the retrieved data. As will be discussed in greater detail below, the generated audience profile models may be configured to generate estimated audience profiles for websites that may represent or approximate audience profiles generated by reference data provider 226.

As discussed herein and discussed in greater detail below, an estimated audience profile may characterize or represent an estimate of an audience profile of a website that may be generated by reference data provider 226, which may be an information and measurement entity such as The Nielsen Company. However, the estimated audience profile may be generated based on data retrieved from the online advertisement service provider.

Accordingly, by using audience profile models to generate estimated audience profiles, access to subsequent reference data might not be required, and audience profiles for websites may be generated that estimate what the reference data would be if it were obtained. In this way, data analyzer 216 may be configured to estimate reference data and corresponding audience profiles based on available audience profile data that has been aggregated by the online advertisement service provider.

Accordingly, data analyzer 216 may include audience profile data aggregator 218 which may be configured to retrieve data from various different data sources that forms the underlying data for the subsequent generation of audience profile models. Accordingly, audience profile data aggregator 218 may be configured to retrieve reference data from one or more online entities which may have generated the reference data, such as reference data provider 226. In some embodiments, reference data may include one or more reports generated by The Nielsen Company. The reports may include reference data that characterizes the results of the implementation of one or more online advertisement campaigns on one or more websites. For example, a report may include reference data that characterizes how many males were served impressions, how many females were served impressions, how many users 18-25 years of age were served impressions, as well as how many instances of a type of data event, such as a click, occurred. The reference data may also characterize (e.g., measure or count) other types of profile descriptive data, such as personal or professional interests, employment status, home ownership, knowledge of languages, age, education level, gender, race and/or ethnicity, income, marital status, religion, size of family, field of expertise, residential location (country, state, DMA, etc.), travel location, etc. The reference data may also characterize other types of events, such as searches performed, purchases made, user account creation, website login events, etc. In some embodiments, the report may be specific to a website and may report such reference data only for that particular website's implementation of an online advertisement campaign.

In various embodiments, reference data received from reference data provider 226 may be generated using reference data provider 226's data sources which, as discussed above, may be vast and expansive.

In various embodiments, audience profile data aggregator 218 may be further configured to retrieve data from a data storage system, such as data storage system 210, which may be operated and maintained by an online advertisement service provider. As similarly discussed above, the online advertisement service provider may aggregate audience profile data, which may include performance data, over the course of implementation of various online advertisement campaigns across many different websites. In various embodiments, audience profile data aggregator 218 may be configured to query the audience profile data stored in data storage system 210 and retrieve any relevant audience profile data. For example, when analyzing a particular website to build an audience profile model, all audience profile data generated by that website may be identified and retrieved by audience profile data aggregator 218 for subsequent analysis, as will be discussed in greater detail below. Further still, audience profile data aggregator 218 may be configured to retrieve additional data from a third party data provider, such as third party data provider 228. In various embodiments, audience profile data aggregator 218 may periodically receive data from third party data provider 228 and may integrate the received data with audience profile data stored in data storage system 210 and/or database system 212.

While a single reference data provider and a single third party data provider are shown, multiple reference data providers and third party data providers may be coupled to data analyzer 216 and audience profile data aggregator 218. As discussed above and in greater detail below, audience profile data aggregator 218 may be further configured to retrieve data stored in data storage system 210 for subsequent data processing.

Data analyzer 216 may further include data structure generator 220 which may be configured to generate one or more data structures based on the data retrieved by audience profile data aggregator 218. In various embodiments, the generation of the data structures orders or arranges the data into representations of the data that may be subsequently processed by audience profile model generator 222, discussed in greater detail below, to generate audience profile models. In some embodiments, the retrieved data may be arranged into data structures that are vector arrays. Accordingly, each website may have a corresponding data structure that is a vector generated based on the reference data and another corresponding data structure that is a vector generated based on the audience profile data. In this way, data structure generator 220 may be configured to generate vectors that represent the reference data and audience profile data for each website being analyzed by data analyzer 216.

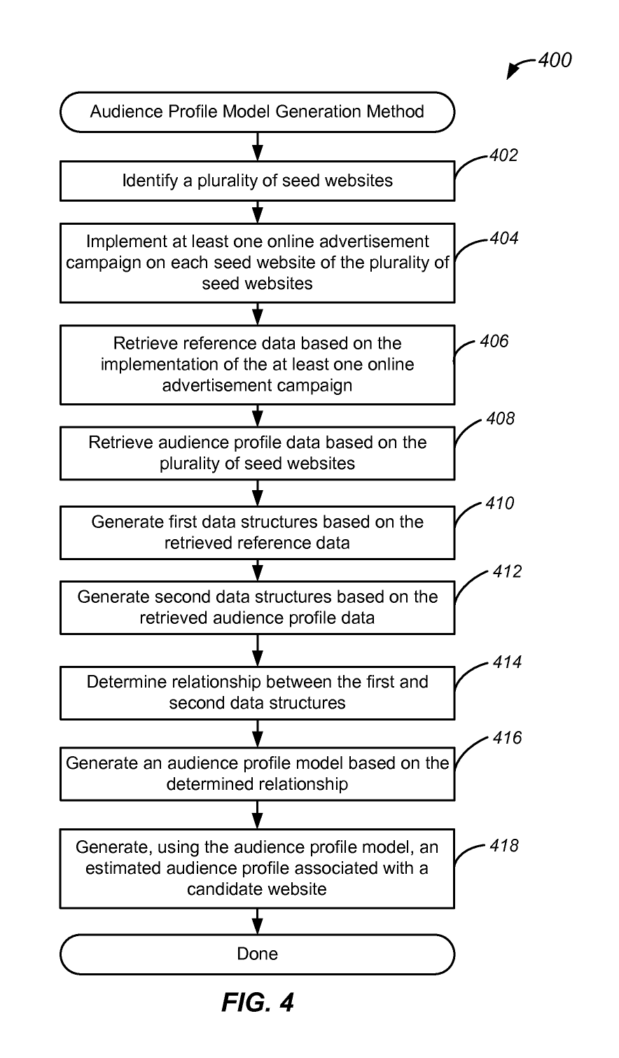

In various embodiments, the vectors may include a column of data fields that represent one or more statistical metrics associated with different features of the underlying data represented by the vector. For example, a vector that represents reference data associated with a website may include a first data field configured to store a data value that identifies an average number of beacon fires generated by a first tracking pixel for users having a given feature or data category, such as a gender. As will be discussed in greater detail below with reference to FIG. 4, the vector may further include additional data fields that store data values identifying other statistical metrics, such as a mean, a median, a maximum value, and a minimum value. Vectors generated based on audience profile data may similarly store data values representing data collected by the online advertisement service provider for similar data categories for that same website.

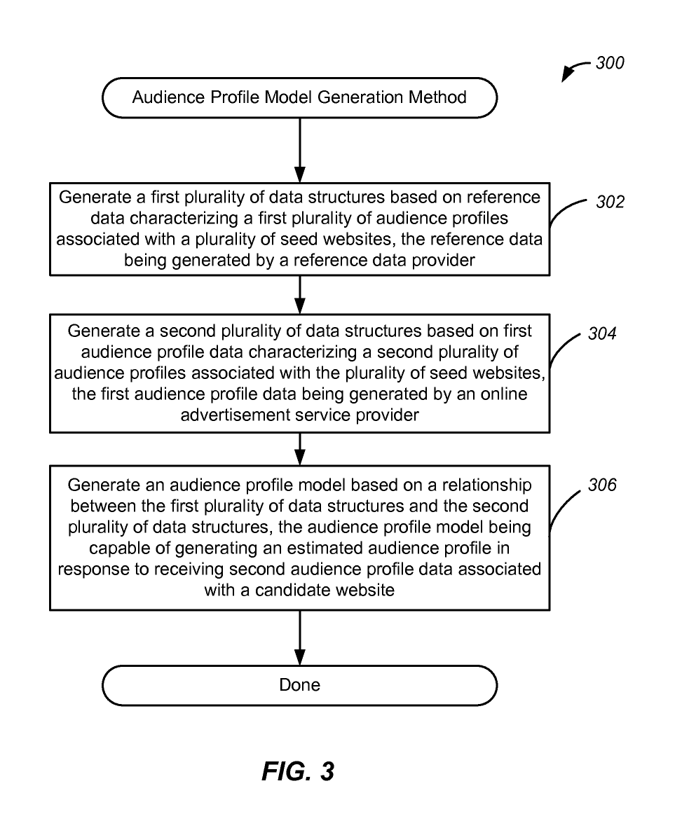

Data analyzer 216 may also include audience profile model generator 222 which may be configured to generate and utilize audience profile models. In various embodiments an audience profile model may be a computational model that may be configured to receive audience profile data generated by an online advertisement service provider, and further configured to generate at least one estimated audience profile in response to receiving the audience profile data. As similarly discussed above, the estimated audience profile may approximate or estimate data that would have been received from reference data provider 226, and, according to some embodiments, such an estimation or approximation may be based on the received audience profile data. Accordingly, while some reference data may be used to generate the audience profile model initially, subsequent utilization of the audience profile model may utilize no reference data, and may generate estimated audience profiles based on audience profile data received from the online advertisement service provider, as will be discussed in greater detail below with reference to FIG. 3 and FIG. 4. In this way, audience profile model generator 222 may be configured to analyze the data structures generated based on reference data and audience profile data, analyze a relationship and/or difference and variances between the different data sets, and generate a model that determines or identifies mathematical operations that may be performed on the audience profile data to transform or modify the data to approximate or estimate the reference data.

In various embodiments, data analyzer 216 or any of its respective components may include one or more processing devices configured to process data records received from various data sources. In some embodiments, data analyzer 216 may include one or more communications interfaces configured to communicatively couple data analyzer 216 to other components and entities, such as a data storage system and a record synchronizer. Furthermore, as similarly stated above, data analyzer 216 may include one or more processing devices specifically configured to process audience profile data associated with data events, online users, and websites. In one example, data analyzer 216 may include several processing nodes, specifically configured to handle processing operations on large data sets. For example, data analyzer 216 may include a first processing node configured as audience profile data aggregator 218, a second processing node configured as data structure generator 220, and a third processing node configured as audience profile model generator 222. In another example, audience profile data aggregator 218 may include big data processing nodes for processing large amounts of performance data in a distributed manner.

In one specific embodiment, data analyzer 216 may include one or more application specific processors implemented in application specific integrated circuits (ASICs) that may be specifically configured to process large amounts of data in complex data sets, as may be found in the context referred to as “big data.”

In some embodiments, the one or more processors may be implemented in one or more reprogrammable logic devices, such as a field-programmable gate array (FPGAs), which may also be similarly configured. According to various embodiments, data analyzer 216 may include one or more dedicated processing units that include one or more hardware accelerators configured to perform pipelined data processing operations. For example, as discussed in greater detail below, operations associated with the generation of audience profiles and audience profile models may be handled, at least in part, by one or more hardware accelerators included in data structure generator 220 and audience profile model generator 222.

In various embodiments, such large data processing contexts may involve performance data stored across multiple servers implementing one or more redundancy mechanisms configured to provide fault tolerance for the performance data. In some embodiments, a MapReduce-based framework or model may be implemented to analyze and process the large data sets disclosed herein. Furthermore, various embodiments disclosed herein may also utilize other frameworks, such as .NET or grid computing.

In various embodiments, system 200 may include data storage system 210. In some embodiments, data storage system 210 may be implemented as a distributed file system. As similarly discussed above, in the context of processing online advertising data from the above described data sources, there may be many terabytes of log files generated every day. Accordingly, data storage system 210 may be implemented as a distributed file system configured to process such large amounts of data. In one example, data storage system 210 may be implemented as a Hadoop® Distributed File System (HDFS) that includes several Hadoop® clusters specifically configured for processing and computation of the received log files. For example, data storage system 210 may include two Hadoop® clusters where a first cluster is a primary cluster including one primary namenode, one standby namenode, one secondary namenode, one Jobtracker, and one standby Jobtracker. The second node may be utilized for recovery, backup, and time-costing query. Furthermore, data storage system 210 may be implemented in one or more data centers utilizing any suitable multiple redundancy and failover techniques.

In various embodiments, system 200 may also include database system 212 which may be configured to store data generated by data analyzer 216. In some embodiments, database system 212 may be implemented as one or more clusters having one or more nodes. For example, database system 212 may be implemented as a four-node RAC (Real Application Cluster). Two nodes may be configured to process system metadata, and two nodes may be configured to process various online advertisement data, which may be performance data, that may be utilized by data analyzer 216. In various embodiments, database system 212 may be implemented as a scalable database system which may be scaled up to accommodate the large quantities of online advertising data handled by system 200. Additional instances may be generated and added to database system 212 by making configuration changes, but no additional code changes.

In various embodiments, database system 212 may be communicatively coupled to console servers 214 which may be configured to execute one or more front-end applications. For example, console servers 214 may be configured to provide application program interface (API) based configuration of advertisements and various other advertisement campaign data objects. Accordingly, an advertiser may interact with and modify one or more advertisement campaign data objects via the console servers. In this way, specific configurations of advertisement campaigns may be received via console servers 214, stored in database system 212, and accessed by advertisement servers 208 which may also be communicatively coupled to database system 212. Moreover, console servers 214 may be configured to receive requests for analyses of performance data, and may be further configured to generate one or more messages that transmit such requests to other components of system 200.

FIG. 3 illustrates a flow chart of an example of an audience profile model generation method, implemented in accordance with some embodiments. As similarly discussed above, an online advertisement service provider may generate audience profiles that characterize or represent an audience population served by various websites. Audience profiles generated based on data maintained by the online advertisement service provider may vary or differ from audience profiles generated by a reference data provider which may have access to a large number of high-quality data sources that may be regarded as a “gold-standard” of data. Accordingly, an audience profile model generation method, such as method 300 may be implemented to analyze data and generate one or more audience profile models that may be used to estimate the reference data of the reference data provider as well as audience profiles for websites that may be generated based on such reference data.

Accordingly, method 300 may commence at operation 302 during which a first plurality of data structures may be generated based on reference data characterizing a first plurality of audience profiles associated with a plurality of seed websites. In some embodiments, the reference data may be generated by a reference data provider. Accordingly, several seed websites may be identified and utilized for the initial generation of the audience profile model. As will be discussed in greater detail below with reference to FIG. 4, an online advertisement campaign may be run on each of the seed websites, and a report may be generated by the reference data provider for each website. The reports may be retrieved by a system component, such as an audience profile data aggregator, and data structures may be generated based on the retrieved data by another system component, such as a data structure generator.

Method 300 may proceed to operation 304 during which a second plurality of data structures may be generated based on first audience profile data characterizing a second plurality of audience profiles associated with the plurality of seed websites. In some embodiments, the first audience profile data may be generated by an online advertisement service provider. As discussed above, several seed websites may be identified and utilized for the initial generation of the audience profile model. Accordingly a system component, such as an audience profile data aggregator, may be configured to query a data storage system operated and maintained by an online advertisement service provider. The audience profile data aggregator may be further configured to anonymously identify and retrieve any relevant audience profile data, such as clicks and impressions, that may have been provided by each website of the seed websites. Moreover, the data structure generator may be further configured to generate additional data structures based on the retrieved audience profile data.

Method 300 may proceed to operation 306 during which an audience profile model may be generated based on a relationship between the first plurality of data structures and the second plurality of data structures. In some embodiments, the audience profile model may be capable of generating an estimated audience profile in response to receiving second audience profile data associated with a candidate website. Accordingly, a system component, such as an audience profile model generator, may analyze the data structures generated based on the reference data and the data structures generated based on the audience profile data. The audience profile model generator may analyze variances, differences, and relationships between the two groups of data structures to generate an audience profile model capable of approximating or estimating reference data based on received audience profile data. As will be discussed in greater detail below with reference to FIG. 4, when audience profile data associated with candidate websites is provided to the audience profile model, estimated audience profiles may be generated for the candidate websites without utilizing any additional reference data.

FIG. 4 illustrates a flow chart of an example of another audience profile model generation method, implemented in accordance with some embodiments. As similarly discussed above, an online advertisement service provider may generate audience profiles that characterize or represent an audience population served by various websites. In various embodiments, an audience profile model generation method, such as method 400 may be implemented to analyze data and generate one or more audience profile models that may be used to estimate the reference data of the reference data provider as well as audience profiles that may be generated based on such reference data. As will be discussed in greater detail below, an online advertisement service provider may use the audience profile model to estimate what an audience profile would be for one or more candidate websites. Accordingly, when given a candidate website, data stored and maintained by the online advertisement service provider may be fed into an audience profile model, and the audience profile model may generate an estimated audience profile for that particular candidate website. As will be discussed in greater detail below, this may be performed for a large volume of data associated with many candidate websites. Because no additional reference data is necessary, the processing of candidate websites may be implemented such that an online advertiser may be provided with forecasts and recommendations in real-time.

Method 400 may commence with operation 402 during which a plurality of seed websites may be identified. In various embodiments, a seed website may be a website that has been selected to generate the underlying data that will subsequently be used to generate the audience profile model. For example, a sample size of 50 seed websites may be identified and selected for analysis. Such websites may include well-trafficked websites such as Yahoo®, MSN®, and USAToday®. In various embodiments, the seed websites may be selected randomly, or may be selected based on a feature or characteristic of the websites. For example, the seed websites may be selected based on an amount of internet traffic handled by each website, an amount of users served by each website, or any other suitable metric or characteristic. In this example, the top 50 websites that have the most users may be selected as seed websites.

In various embodiments, seed websites may be identified based on one or more audience profile characteristics which may be determined based on existing audience profile data that may have been previously collected by an online advertisement service provider during previous implementations of online advertisement campaigns. In some embodiments, the audience profile characteristics may be determined based on one or more reports generated by an independent survey agency or the online advertisement service provider. The reports may include data obtained via a phone or online survey, or by synchronizing user data with offline data such as credit card purchase data. Once such audience profile characteristics have been determined, they may form the basis of identifying one or more seed websites. For example, a website may be identified as a seed website if 70% visitors are female and 30% visitors are male. Moreover a website might not be identified as a seed website if 50% of visitors are female and 50% of visitors are male.

Method 400 may proceed to operation 404 during which at least one online advertisement campaign may be implemented on each seed website of the plurality of seed websites. Accordingly, once the seed websites have been selected, at least one online advertisement campaign may be selected and implemented on each website for a designated period of time. During this period of time, an implemented online advertisement campaign may serve impressions and advertisement content to users of the seed websites, and data events characterizing interactions between the users and the online advertisement campaigns may be generated. In various embodiments, a different online advertisement campaign may be implemented on each seed website. Accordingly, if 50 seed websites have been selected, then 50 different online advertisement campaigns may be selected and implemented, where one online advertisement campaign is implemented on each seed website. In various embodiments, the selection of the online advertisement campaigns may be random, or may be selected based on an online advertiser identifier.

Method 400 may proceed to operation 406 during which reference data may be retrieved based on the implementation of the at least one online advertisement campaign. In various embodiments, the implementation of the online advertisement campaigns on the seed websites may generate reference data stored and maintained by the reference data provider. For example, a reference data provider, such as The Nielsen Company, may monitor activities performed by each of the seed websites when implementing the online advertisement campaigns. Accordingly, the reference data provider may monitor and record data events and users associated with the data events. Moreover, the reference data provider may also store and maintain extensive user profile data that includes various user data associated with each user. Accordingly, in addition to data characterizing the data events that occurred when implementing the online advertisement campaign, the reference data may also include extensive data characterizing various features of the users associated with those data events. As discussed above, the reference data provider may have access to extensive data resources as well as data sources that are highly accurate. Accordingly, the reference data may include details and highly accurate information about the users associated with the data events generated during the implementation of the online advertisement campaign. As discussed above, the reference data is represented as aggregate data and does not include data specific to a particular user, but instead includes aggregate user data over a period of time.

Method 400 may proceed to operation 408 during which audience profile data may be retrieved based on the plurality of seed websites. As similarly discussed above, the audience profile data may be stored and maintained by an online advertisement service provider. Accordingly, data characterizing features of users that may be included in the audience profile data may have been retrieved from different data sources than the data sources of the reference data provider. In some embodiments, the audience profile data may have been retrieved from advertisement servers and third party data providers which may be less accurate than the reference data provider. In various embodiments, the audience profile data may be queried and any relevant data may be identified and retrieved. The query may be performed based on a website identifier that may be an identifier that is unique to a particular website. Accordingly, the audience profile data may be queried based on the website identifier, and audience profile data, which may include data events and user profile data associated with those data events, that includes matching identifiers may be retrieved as a result of the query.

Method 400 may proceed to operation 410 during which first data structures may be generated based on the retrieved reference data. As similarly discussed above, data structures may be generated by a system component, such as a data structure generator, based on data retrieved by another system component, such as an audience profile data aggregator. The generation of the data structures orders or arranges the data into representations of the data that may be subsequently processed by an audience profile model generator. As discussed above, the implementation of the online advertisement campaigns on the seed websites may generate data events and associated user data that may be included and retrieved as reference data. In some embodiments, the reference data may be retrieved as a plurality of data records, where each data record includes a report for a particular website. Accordingly, for 50 seed websites, 50 data records may be retrieved and may be processed to generate 50 first data structures.

In various embodiments, the first data structures may be vectors. Accordingly, each of the first data structures may be a vector that includes a column of data characterizing or representing the data included in a data record of the reference data. A vector for a particular seed website may include a column of data fields each storing one or more data values. In various embodiments, the data values may be calculated based on aggregated data for each data category associated with users identified by the reference data. For example, for each data category included in the reference data, a sum, mean, median, and max value and min value may be calculated. Such values may be calculated across an entire website visitor population. In some embodiments, the calculated values may be concatenated to generate a vector for each website. In this way, the data fields of the first data structure may represent the activity recorded by a reference data provider for many different online advertisement campaigns implemented on a seed website, as well as user profile data associated with that activity. In the example of a data structure that is a vector, the vector may be configured as an array of data values each corresponding to a data category, where the data categories may be identified by a system component based on the retrieved data as well as a previously stored table of data categories which may have been generated during previous implementations of online advertisement campaigns. In one example, a vector may be generated that has a structure defined by data categories associated with an array of data fields such as <male, female, young, old>, where each of male, female, young, and old are separate data categories. The vector may store values such as <100, 150, 200, 50>which each correspond to aggregate data for each data category. As discussed above and in greater detail below, the reference data may be provided as such aggregate data. In various embodiments, as will be discussed in greater detail below, the third party data may be provided as individual user vectors which are subsequently modified by a system component to generate aggregate vectors.

Moreover, different data fields may correspond to different types of aggregate statistics. For example, a first data field may store a total number of clicks that occurred for a given data category, such as a gender of a user, a second data field may include a mean representing an average number of clicks per user for the given data category, and a third data field may include a median representing a middle of a distribution of the number of clicks per user for the given data category. Similar data may be stored for other data event types and other data categories associated with users. In this way, the data fields of the vector may represent the activity recorded by a reference data provider for an online advertisement campaign implemented on a seed website, as well as user profile data associated with that activity.

Method 400 may proceed to operation 412 during which second data structures may be generated based on the retrieved audience profile data. In some embodiments, each of the second data structures may be a vector that includes a column of data characterizing or representing the data included in the retrieved audience profile data. For example, audience profile data may be retrieved for each seed website as part of a query performed on the data storage system operated and maintained by the online advertisement service provider.

Accordingly, the retrieved audience profile data may be partitioned based on website identifiers included in the data, or separate queries may return different result objects for each seed website. A system component, such as a data structure generator, may generate a vector for each seed website that may include a column of data fields each storing one or more data values. In some embodiments, the column of data fields included in the second data structures may be configured to store the same or similar types of data as the column of data fields included in the first data structures. The first and second data structures may have the same or similar overall structures, but may have different data values stored within them.

As previously discussed, when a user opens a website, a demand-side platform provided by an online advertisement service provider may receive a request to send bid for an auction. The request may be a message that includes data characterizing the website uniform resource locator (URL) and a unique ID that identifies the user who opened the website. In various embodiments, the online advertisement service provider may have previously stored data associated with the user that characterizes previous online activity associated with the user. For example, based on the user's previous activities, the online advertisement service provider may already have stored data characterizing how many times this user has fired a specific beacon. As discussed above, a beacon may be a transparent graphic image about 1 pixel by 1 pixel that is placed on the website or in an e-mail, and is used to identify activity generated by the user when visiting the website or sending the email. The online advertisement service provider may also have previously stored data characterizing what the user's demographic status is. Such data may have been previously retrieved as third party data received form a third party data provider such as DataLogix, and may include data characterizing features of the user such as the user's age, gender, and income. The online advertisement service provider may additionally have previously stored data characterizing what the user's behavior has been as may be identified based on how often he or she visits a particular type of website, such as a sports website, and how likely it is that the user will click on advertisements on the websites.

Accordingly, for a particular website, a system component may analyze all auction requests within a specified time window, which may be a previous month. Data for each user associated with the auction requests may also be analyzed. For example, the data may include several data categories or tags which characterize various different features of the users. In some embodiments, each data category may be designated as a variable upon which one or more operations may be performed. For example, for each data category, a sum, mean, median, and max value and min value may be calculated. Such values may be calculated across an entire website visitor population. In some embodiments, the calculated values may be concatenated to generate a vector for each website.

Accordingly, as similarly discussed above, a first data field of a second data structure may store a total number of clicks that occurred for a given data category, such as a gender of a user, a second data field may include a mean representing an average number of clicks per user for the given data category, and a third data field may include a median representing a middle of a distribution of the number of clicks per user for the given data category. Various other calculated values for each feature or data category associated with the users may also be included in the second data structure. In this way, the data fields of the second data structure may represent the activity recorded by an online advertisement service provider for many different online advertisement campaigns implemented on a seed website, as well as user profile data associated with that activity.

Method 400 may proceed to operation 414 during which a relationship between the first and second data structures may be determined. In various embodiments, the relationship may characterize a difference between the data underlying the first data structures and the second data structures. In some embodiments, the first data structures and second data structures may be used as training data for a regression algorithm. Returning to a previous example, if 50 seed websites have been selected, there may be 50 first data structures generated based on the reference data as well as 50 second data structures generated based on the audience profile data. These two sets of 50 data structures may be included in training data and used to train a regression model. It will be appreciated that this may be performed for any suitable number of seed websites. In some embodiments, the regression model may be a linear regression model, a logistic regression model, a neural network, a support vector regression model, or a machine learning model.

As will be discussed in greater detail below, the regression model may be stored as an audience profile model that may be configured to receive input data that may include audience profile data for a candidate website, and may be further configured to generate an output that includes an estimated audience profile for that candidate website. For example, the audience profile model may be configured to receive vectors including audience profile data for candidate websites. In one example, a vector may include a first element that is a number of female users reported from a first data provider, a second element that is a number of female users reported from a second data provider, a third element that is a number of young users from a third data provider, a fourth element that is a number of users that have first beacon fires, a fifth element that is a number of users that have second beacon fires, etc.

The output generated by the audience profile model may also be a vector, where a first element is an estimated number of female users, a second element is an estimated number of young users, etc. In various embodiments, the generated output might not be a vector, but might be a real number, such as an estimated number of female users.

In various embodiments, features included in the training data may be filtered prior to training the regression models. As similarly discussed above, different data fields of the data structures may correspond to or represent different features of the data underlying the data structures. In some embodiments, the features may be filtered to modify or select particular features that should be used to train the regression models. The features may be filtered based on one or more parameters received from an online advertiser or generated by a system component, such as the audience profile model generator. For example, when configuring an online advertisement campaign, an online advertiser may select or identify one or more features that are highly important to the online advertisement campaign. In some embodiments, the features may be identified based on the targeting criteria initially provided by the online advertiser. Accordingly, the online advertiser may select female users within the age group of 18-25 years old to target for a particular online advertisement campaign relating to designer clothing. Data fields of the data structures that include data corresponding to these identified features may be included in the training data while the other data that does not correspond to these identified features is excluded from the training data.

Moreover, as discussed above, a system component may determine the features used to filter the training data. For example, an audience profile model generator may infer or determine one or more features based on principal component analysis which may implement an orthogonal transformation of the data underlying the first and second data structures. In this way, the principal component analysis may characterize variances between the first data structures and second data structures that may form the basis of the audience profile model.

In another example, the audience profile model generator may infer or determine one or more features based on mutual information ranking which may determine the mutual dependence of the first and second data structures. Thus, mutual information ranking may be implemented to measure the dependence expressed in the joint distribution of the first data structures and second data structures relative to the joint distribution of the first data structures and second data structures under the assumption that they are independent.

In one example, filtering may be applied by providing an input that may be a pair <x, y>, where x is a real number such as the number of female users reported by a reference data provider, and y is a vector where a first element is a number of female users reported from a first data provider, a second element is a number of female users reported from a second data provider, a third element is a number of young users from a third data provider, a fourth element is a number of users that have first beacon fires, a fifth element is a number of users that have second beacon fires, etc. An output may be generated that is a subset of y. In this way, the output may include data values that are a smaller set of elements from y and filtered based on a value of x.

According to some embodiments, the relationship may be determined based on one or more designated rules. In some embodiments, a system component, such as an audience profile model generator, may be configured to generate one or more computational rules based on one or more mathematical operations performed on the above-described training data. For example, a first data field of the first and second data structures may correspond to a number of instances of a first type of data event, which may be a page view. The audience profile model generator may determine that, on average, the number of instances of the data event recorded by the reference data provider was twice as large as the number of instances recorded by the online advertisement service provider. Based on this determination, the audience profile model generator may generate a rule that multiplies the first data field of data structures generated based on audience profile data, as may occur for candidate websites discussed in greater detail below, by a factor or coefficient of two. The audience profile model generator may similarly generate a rule for each data field included in the data structures. The set of rules may be stored and applied to data structures during the subsequent generation of estimated audience profiles, discussed in greater detail below.

Method 400 may proceed to operation 416 during which an audience profile model may be generated based on the determined relationship. Accordingly, once the relationship has been determined the audience profile model may be generated and stored as a data object subsequently accessible by other system components for subsequent analysis. In various embodiments, the audience profile model may be stored in a file system or data storage system operated and maintained by an online advertisement service provider. The audience profile model may be stored as a data object which may subsequently be loaded and implemented at one or more servers, such as servers 206 discussed above with reference to FIG. 2, that may be used to facilitate the implementation of online advertisement operations. Accordingly, once loaded at the servers, the audience profile model may be configured to communicate with advertisers and generate estimated audience profiles for advertisers based on their targeting criteria and data source selections. In some embodiments, the audience profile model may be implemented directly from the data storage system.

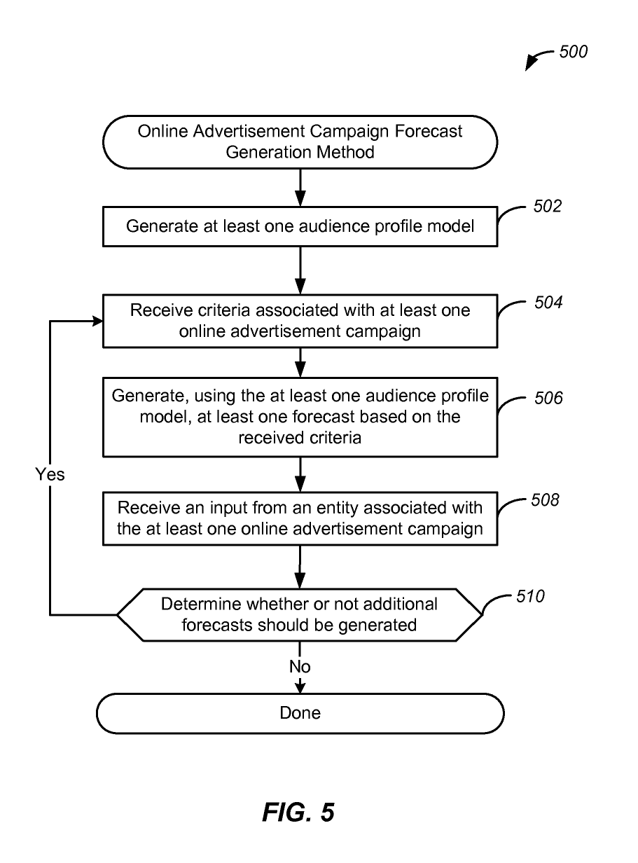

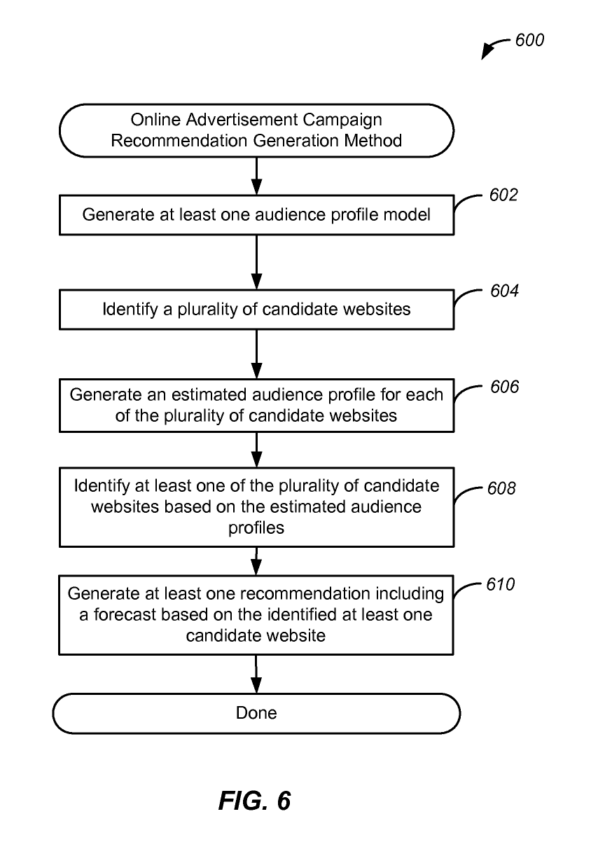

Method 400 may proceed to operation 418 during which an estimated audience profile may be generated using the audience profile model. As discussed above, the audience profile model may be used to estimate reference data associated with candidate websites. Accordingly, for a given a candidate website, which may be different than the seed websites, one or more system components may generate a third data structure based on available audience profile data associated with the candidate website. The third data structure may be provided to the audience profile model which may perform one or more transformations and/or operations upon the third data structure to generate a fourth data structure that represents an estimated audience profile for the candidate website. In this example, the estimated audience profile was generated with no additional reference data, but accurately estimates the audience profile of the candidate website that would result if the online advertisement campaign were implemented and reference data were retrieved. Moreover, this operation may be performed across hundreds, thousands, or millions of websites thus enabling the processing of many different websites for subsequent forecasting and recommendation operations discussed in greater detail below with reference to FIG. 5 and FIG. 6. For example, estimated audience profiles may be generated across 8 to 10 million different websites thus generating an extensive collection of estimated audience profiles that enables the effective and efficient implementation of online advertisement campaigns.

FIG. 5 illustrates a flow chart of an example of an online advertisement campaign forecast generation method, implemented in accordance with some embodiments. As discussed above, an audience profile model may be used to generate an estimate of an audience profile for a candidate website. In some embodiments, numerous candidate websites may be analyzed to generate an overall estimate of the results of implementing an online advertisement campaign across those candidate websites. In this way, an audience profile model may be used to generate an expected outcome of implementing the online advertisement campaign without actually implementing the online advertisement campaign and retrieving reference data for each candidate website.

Accordingly, method 500 may commence with operation 502 during which at least one audience profile model may be generated. As discussed above with reference to FIG. 4, the audience profile model may be generated based on reference data and audience profile data for online advertisement campaigns implemented at several seed websites. As discussed above, the audience profile model may be generated based on an analysis of first data structures and second data structures that were generated based on the reference data and audience profile data.

Method 500 may proceed to operation 504 during which criteria associated with at least one online advertisement campaign may be received. In some embodiments, the criteria may be one or more targeting criteria or parameters that characterize or identify features or data categories associated with online users that an online advertiser intends to target for a particular online advertisement campaign. Accordingly, the criteria may be received from the online advertiser via a user interface provided at a console server, as discussed above with reference to FIG. 2. For example, an online advertiser may enter criteria identifying a particular, gender, age-group, geographical location, and profession.

Method 500 may proceed to operation 506 during which at least one forecast may be generated based on the received criteria. In various embodiments, the at least one forecast may be generated by using the at least one audience profile model. Accordingly, based on received criteria, a system component, such as a data analyzer, may select several candidate websites upon which the online advertisement campaign may be implemented. In various embodiments, the candidate websites may be selected based on a list of known websites which may be ranked or sorted based on one or more features, such as audience size. According to some embodiments, the candidate websites may be selected or identified by a whitelist of websites that may be generated by a system component such as a data analyzer. In various embodiments, the whitelist may be generated based on estimated audience profiles that have been generated for all available websites and then filtered based on their estimated audience profiles. For example, if an advertiser targets a demographic of females between 20 and 25 years old is chosen, estimated audience profiles may be generated and analyzed, and a whitelist may be generated that includes websites that have a percentage of users greater than a designated threshold value. In this way, estimated audience profiles may form the basis of selecting candidate websites for which to generate a forecast. As discussed above, estimated audience profiles may be generated across millions of websites. Accordingly, various embodiments disclosed herein may select candidate websites and generate forecasts based on extensive and massive amounts of estimated audience profiles for websites. In some embodiments, the data analyzer may select the candidate websites randomly.

Once the candidate websites have been selected, audience profile data may be retrieved for each candidate website and provided to the audience profile model. The audience profile model may generate estimated audience profiles for each of the candidate websites. In various embodiments, the generated estimated audience profiles may collectively represent a forecast of an expected result of implementing the online advertisement campaign at the candidate websites. For example, the forecast may include a total number of users reached, as well as a total number of actions or conversions performed Furthermore, the forecast may include representations of subsets of the data, such as the number or percentage of users reached that were female or within a particular age group. In various embodiments, the forecast may also include a total expected cost incurred by advertising to the selected audience population, as well as an expected budget that may be spent on the selected audience population. Accordingly, the data represented in the generated estimated audience profiles may be filtered and presented as a report to an online advertiser via an API of a console server. In some embodiments, the online advertiser may configure the filtering of the data and presentation of the forecast to display specific online advertiser-selected subsets of the data.

Method 500 may proceed to operation 508 during which an input may be received from an entity associated with the at least one online advertisement campaign. In some embodiments, the entity may be an online advertiser. Accordingly, the input may be provided by the online advertiser to a user interface associated with a console server. The input may identify or specify whether or not another forecast should be run. For example, the online advertiser may indicate that a forecast should be run with different targeting criteria, or for a different online advertisement campaign. In some embodiments, the input received from the online advertiser may indicate that one or more candidate websites should be added to or removed from the candidate websites that were used to generate the forecast.

Accordingly, method 500 may proceed to operation 510 during which it may be determined whether or not additional forecasts should be generated. In various embodiments, such a determination may be made based on the input received at operation 508. As discussed above, the input may identify an online advertiser-specified preference or parameter, and additional forecasts may be generated based on the received input. If it is determined that additional forecasts should be generated, method 500 may return to operation 504. If it is determined that no additional forecasts should be generated, method 500 may terminate.

FIG. 6 illustrates a flow chart of an example of online advertisement campaign recommendation generation method, implemented in accordance with some embodiments. Accordingly, an online advertisement campaign recommendation generation method, such as method 600, may be implemented to generate one or more recommendations for an online advertiser that may recommend websites upon which the online advertiser may want to implement an online advertisement campaign. Furthermore, a forecast may be generated for each recommendation, thus providing the online advertiser with an estimate of the results of each recommendation.

Accordingly, method 600 may commence with operation 602 during which at least one audience profile model may be generated. As discussed above with reference to FIG. 4 and FIG. 5, the audience profile model may be generated based on reference data and audience profile data for online advertisement campaigns implemented at several seed websites. As discussed above, the audience profile model may be generated based on an analysis of first data structures and second data structures that were generated based on the reference data and audience profile data.

Method 600 may proceed to operation 604 during which a plurality of candidate websites may be identified. As similarly discussed above with reference to FIG. 5, a system component, such as a data analyzer, may select several candidate websites upon which the online advertisement campaign may be implemented. In various embodiments, the candidate websites may be selected based on a list of known websites which may be ranked or sorted based on one or more features, such as audience size. According to some embodiments, the candidate websites may be selected or identified by a whitelist of websites that may be generated by a system component such as a data analyzer. In some embodiments, the data analyzer may select the candidate websites randomly.

Method 600 may proceed to operation 606 during which an estimated audience profile may be generated for each of the plurality of candidate websites. Accordingly, as discussed above, audience profile data may be retrieved for each of the identified candidate websites and may be provided to the audience profile model. The audience profile model may process the retrieved data and generate an estimated audience profile for each candidate website. In various embodiments, operation 606 may have been performed previously. For example, estimated audience profiles may have been generated previously during a previous iteration of a method, such as method 400 discussed above. Accordingly, during operation 606 previously generated estimated audience profiles associated with the candidate websites may be retrieved from a data storage system and subsequently utilized during operation 608 discussed in greater detail below.

Method 600 may proceed to operation 608 during which at least one of the plurality of candidate websites may be identified based on the estimated audience profiles. Thus, according to various embodiments, candidate websites may be identified or selected based on one or more features or parameters of their corresponding estimated audience profiles. In some embodiments, the candidate websites may be identified based on a correlation between the one or more features of their estimated audience profiles and a set of targeting criteria for the online advertisement campaign. For example, if targeting criteria for an online advertisement campaign indicate that the online advertisement campaign is targeted towards men, candidate websites having an estimated audience profile that indicates an audience of 70% male or greater may be identified. While one example has been provided, any number of features may be used to identify relevant candidate websites.

Method 600 may proceed to operation 610 during which at least one recommendation may be generated that includes a forecast based on the identified at least one candidate website. In various embodiments, the recommendation may be a recommended group or set of candidate websites that should be used to implement an online advertisement campaign. The recommendation may be generated by including one or more of the identified candidate websites. In some embodiments, candidate websites included in a recommendation may be determined based on one or more online advertisement parameters. For example, of the identified candidate websites, five may be selected based on a budgetary constraint of the online advertisement campaign. In various embodiments, multiple recommendations may be generated based on different combinations of identified candidate websites. Furthermore, a forecast may be generated for each recommendation. As similarly discussed above, the forecast may provide an estimate of an outcome of implementing the online advertisement campaign on a set of websites that includes the identified candidate websites for a particular recommendation. In this way, an online advertiser may be provided with a recommendation of candidate websites upon which to implement an online advertisement campaign, as well as a forecast of an outcome of implementing the recommendation. As similarly discussed above, the candidate websites may be selected from millions of websites for which estimated audience profiles have been generated. Accordingly, the recommendation generated during operation 610 may be generated based on an analysis of several candidate websites selected from millions of websites having millions of associated estimated audience profiles.

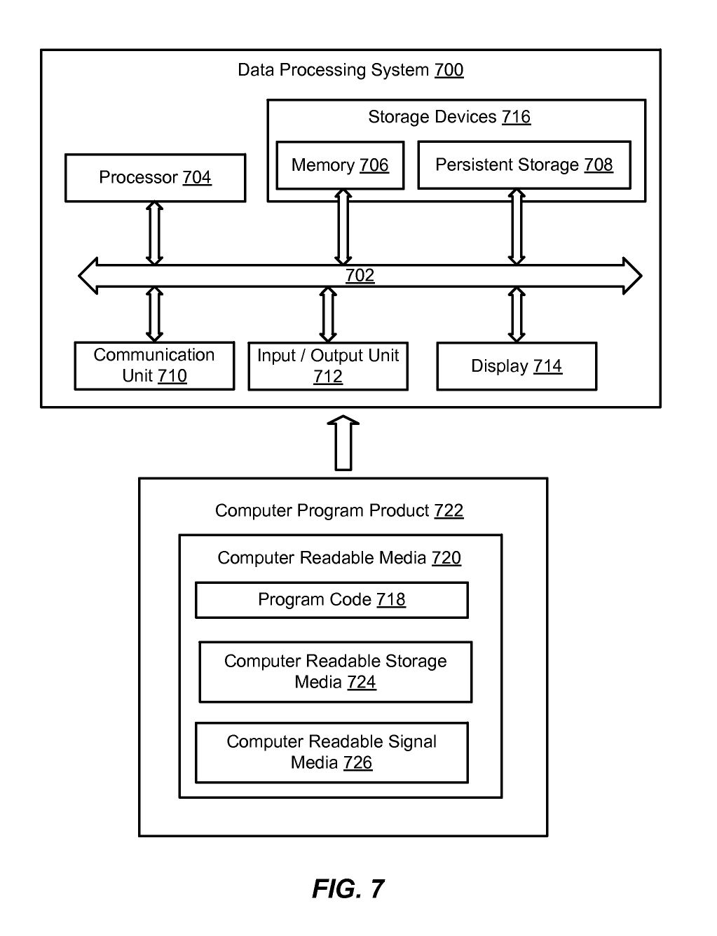

FIG. 7 illustrates a data processing system configured in accordance with some embodiments. Data processing system 700, also referred to herein as a computer system, may be used to implement one or more computers or processing devices used in a controller, server, or other components of systems described above, such as an audience profile model generator. In some embodiments, data processing system 700 includes communications framework 702, which provides communications between processor unit 704, memory 706, persistent storage 708, communications unit 710, input/output (I/O) unit 712, and display 714. In this example, communications framework 702 may take the form of a bus system.

Processor unit 704 serves to execute instructions for software that may be loaded into memory 706. Processor unit 704 may be a number of processors, as may be included in a multi-processor core. In various embodiments, processor unit 704 is specifically configured to process large amounts of data that may be involved when processing reference data and audience profile data associated with one or more advertisement campaigns, as discussed above. Thus, processor unit 704 may be an application specific processor that may be implemented as one or more application specific integrated circuits (ASICs) within a processing system. Such specific configuration of processor unit 704 may provide increased efficiency when processing the large amounts of data involved with the previously described systems, devices, and methods. Moreover, in some embodiments, processor unit 704 may be include one or more reprogrammable logic devices, such as field-programmable gate arrays (FPGAs), that may be programmed or specifically configured to optimally perform the previously described processing operations in the context of large and complex data sets sometimes referred to as “big data.”

Memory 706 and persistent storage 708 are examples of storage devices 716. A storage device is any piece of hardware that is capable of storing information, such as, for example, without limitation, data, program code in functional form, and/or other suitable information either on a temporary basis and/or a permanent basis. Storage devices 716 may also be referred to as computer readable storage devices in these illustrative examples. Memory 706, in these examples, may be, for example, a random access memory or any other suitable volatile or non-volatile storage device. Persistent storage 708 may take various forms, depending on the particular implementation. For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that may be connected to data processing system 700. For example, input/output unit 712 may provide a connection for user input through a keyboard, a mouse, and/or some other suitable input device. Further, input/output unit 712 may send output to a printer. Display 714 provides a mechanism to display information to a user.

Instructions for the operating system, applications, and/or programs may be located in storage devices 716, which are in communication with processor unit 704 through communications framework 702. The processes of the different embodiments may be performed by processor unit 704 using computer-implemented instructions, which may be located in a memory, such as memory 706.

These instructions are referred to as program code, computer usable program code, or computer readable program code that may be read and executed by a processor in processor unit 704. The program code in the different embodiments may be embodied on different physical or computer readable storage media, such as memory 706 or persistent storage 708.

Program code 718 is located in a functional form on computer readable media 720 that is selectively removable and may be loaded onto or transferred to data processing system 700 for execution by processor unit 704. Program code 718 and computer readable media 720 form computer program product 722 in these illustrative examples. In one example, computer readable media 720 may be computer readable storage media 724 or computer readable signal media 726.

In these illustrative examples, computer readable storage media 724 is a physical or tangible storage device used to store program code 718 rather than a medium that propagates or transmits program code 718.

Alternatively, program code 718 may be transferred to data processing system 700 using computer readable signal media 726. Computer readable signal media 726 may be, for example, a propagated data signal containing program code 718. For example, computer readable signal media 726 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 700 are not meant to provide architectural limitations to the manner in which different embodiments may be implemented. The different illustrative embodiments may be implemented in a data processing system including components in addition to and/or in place of those illustrated for data processing system 700. Other components shown in FIG. 7 can be varied from the illustrative examples shown. The different embodiments may be implemented using any hardware device or system capable of running program code 718.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A system comprising:
a data structure generator configured to generate a first plurality of data structures based on reference data characterizing a first plurality of audience profiles associated with a plurality of seed websites, the reference data being generated by a reference data provider,
the data structure generator being further configured to generate a second plurality of data structures based on first audience profile data characterizing a second plurality of audience profiles associated with the plurality of seed websites, the first audience profile data being generated by an online advertisement service provider; and
an audience profile model generator configured to generate an audience profile model based on a relationship between the first plurality of data structures and the second plurality of data structures, the audience profile model generator being further configured to generate, using the audience profile model, an estimated audience profile in response to receiving second audience profile data associated with a candidate website.

2. The system of claim 1, wherein the first data structures include a first plurality of data fields, wherein each data field of the first plurality of data fields is configured to store one or more data values characterizing a data event or user profile data included in the reference data.

3. The system of claim 2, wherein the second data structures include a second plurality of data fields, wherein each data field of the second plurality of data fields is configured to store one or more data values characterizing a data event or user profile data included in the first audience profile data.

4. The system of claim 3, wherein the first plurality of data fields included in the first data structures and the second plurality of data fields included in the second data structures are arranged as vector arrays.

5. The system of claim 1, wherein the relationship between the first plurality of data structures and the second plurality of data structures is determined based on a regression analysis between the first data structures and the second data structures.

6. The system of claim 1, wherein the relationship between the first plurality of data structures and the second plurality of data structures is determined based on a plurality of rules generated by the audience profile model generator, each rule of the plurality of rules being generated based on a comparison of the reference data and the first audience profile data.

7. The system of claim 1, wherein the estimated audience profile represents an estimate of an audience profile generated by the reference data provider in response to an online advertisement campaign being implemented on the candidate website.

8. The system of claim 7, wherein the candidate website is different than each seed website of the plurality of seed websites.

9. The system of claim 1 further comprising:
a data analyzer configured to generate a forecast based, at least in part, on the estimated audience profile, the forecast including a prediction of an outcome of implementing an online advertisement campaign on the candidate website.

10. The system of claim 9, wherein the data analyzer is further configured to generate a recommendation based, at least in part, on the estimated audience profile, the recommendation identifying whether the online advertiser should implement the online advertisement campaign on the candidate website.

11. A system comprising:
at least a first processing node configured to generate a first plurality of data structures based on reference data characterizing a first plurality of audience profiles associated with a plurality of seed websites, the reference data being generated by a reference data provider;
at least a second processing node configured to generate a second plurality of data structures based on first audience profile data characterizing a second plurality of audience profiles associated with the plurality of seed websites, the first audience profile data being generated by an online advertisement service provider; and
at least a third processing node configured to generate an audience profile model based on a relationship between the first plurality of data structures and the second plurality of data structures, the at least a third processing node being further configured to generate, using the audience profile model, an estimated audience profile in response to receiving second audience profile data associated with a candidate website.

12. The system of claim 11, wherein the first data structures include a first plurality of data fields, wherein each data field of the first plurality of data fields is configured to store one or more data values characterizing a data event or user profile data included in the reference data, and
wherein the second data structures include a second plurality of data fields, wherein each data field of the second plurality of data fields is configured to store one or more data values characterizing a data event or user profile data included in the first audience profile data.

13. The system of claim 11, wherein the relationship between the first plurality of data structures and the second plurality of data structures is determined based on a regression analysis between the first data structures and the second data structures.

14. The system of claim 11, wherein the estimated audience profile represents an estimate of an audience profile generated by the reference data provider in response to an online advertisement campaign being implemented on the candidate website.

15. The system of claim 14, wherein the candidate website is different than each seed website of the plurality of seed websites.

16. One or more non-transitory computer readable media having instructions stored thereon for performing a method, the method comprising:
generating a first plurality of data structures based on reference data characterizing a first plurality of audience profiles associated with a plurality of seed websites, the reference data being generated by a reference data provider;
generating a second plurality of data structures based on first audience profile data characterizing a second plurality of audience profiles associated with the plurality of seed websites, the first audience profile data being generated by an online advertisement service provider; and
generating an audience profile model based on a relationship between the first plurality of data structures and the second plurality of data structures, the audience profile model being capable of generating an estimated audience profile in response to receiving second audience profile data associated with a candidate website.

17. The one or more non-transitory computer readable media of claim 16, wherein the first data structures include a first plurality of data fields, wherein each data field of the first plurality of data fields is configured to store one or more data values characterizing a data event or user profile data included in the reference data, and
wherein the second data structures include a second plurality of data fields, wherein each data field of the second plurality of data fields is configured to store one or more data values characterizing a data event or user profile data included in the first audience profile data.

18. The one or more non-transitory computer readable media of claim 16, wherein the relationship between the first plurality of data structures and the second plurality of data structures is determined based on a regression analysis between the first data structures and the second data structures.

19. The one or more non-transitory computer readable media of claim 16, wherein the estimated audience profile represents an estimate of an audience profile generated by the reference data provider in response to an online advertisement campaign being implemented on the candidate website.

20. The one or more non-transitory computer readable media of claim 16, wherein the method further comprises:
generating a forecast based, at least in part, on the estimated audience profile, the forecast including a prediction of an outcome of implementing an online advertisement campaign on the candidate website; and
generating a recommendation based, at least in part, on the estimated audience profile, the recommendation identifying whether the online advertiser should implement the online advertisement campaign on the candidate website.
